(19) United States
(12) Patent Application Publication
(10) Pub. No.: US 2019/0135255 A1
(43) Pub. Date: May 9, 2019

(54) Method for Operating an Electromechanical Brake Device

(71) Applicant: Robert Bosch GmbH, Stuttgart (DE)

(72) Inventors: Frank Baehrle-Miller, Schoenaich (DE); Helmut Wolff, Untergruppenbach (DE)

(21) Appl. No.: 16/307,307

(22) PCT Filed: Apr. 24, 2017
(86) PCT No.: PCT/EP2017/059597

§ 371 Date: Dec. 5, 2018

(30) Foreign Application Priority Data
Jun. 8, 2016 (DE) 10 2016 210 081.5

(51) Int. Cl. B60T 13/58; B60T 13/66; B60T 13/74; B60T 7/04

(52) U.S. Cl. CPC B60T 13/588; B60T 13/662; F16D 2121/04; B60T 7/042; B60T 13/741

(57) ABSTRACT

A method for operating an electromechanical brake device transmits the rotational motion of the electric brake motor to the brake piston by way of an axially movable transmitting element. In the instance that the brake piston lies at a distance relative to an associated brake pad, a hydraulic brake pressure is produced in a hydraulic vehicle brake.

The invention concerns a method for operating an electromechanical braking device comprising an electric brake motor to produce a braking force.

### PRIOR ART

From DE 10 2004 004 992 A1, a brake system for a vehicle is known that on the one hand comprises a hydraulic vehicle brake for producing a braking force during regular brake operation and on the other hand comprises an electromechanical braking device with an electric brake motor for producing a braking force when the vehicle is at a standstill. The electric brake motor acts on the same brake piston as the hydraulic vehicle brake and displaces a brake lining on the end face of the brake piston against a brake disk.

A corresponding brake system is also described in DE 10 2010 040 573 A1.

### DISCLOSURE OF THE INVENTION

The method according to the invention can be used in vehicles with a brake system that comprises a hydraulic vehicle brake and at least one electromechanical braking device with an electric brake motor. During regular brake operation, the vehicle is decelerated by operating the hydraulic vehicle brake. The electromechanical braking device is preferably used to hold the vehicle at a standstill by actuating the electric brake motor and electromechanically producing a braking force that holds the vehicle stationary.

The electromechanical braking device is integrated within a wheel brake device of the hydraulic vehicle brake and the brake piston in the wheel brake device can be displaced towards the brake disk both by the hydraulic brake fluid of the hydraulic vehicle brake and at the same time or mutually independently by the electric brake motor. The electromechanical braking device is preferably used as a parking brake to hold the vehicle at a standstill. The electromechanical braking device with the brake motor may also be used to reduce the speed of the vehicle while the vehicle is being driven. According to a preferred embodiment, a respective electromechanical braking device is disposed in both wheel brake devices on the rear axle.

Using the method according to the invention, the at least one electromechanical braking device can be operated and the operation can be maintained. For proper operation of the electromechanical braking device, the brake piston must be displaced axially—in relation to the longitudinal axis of the piston—by the electric brake motor of the electromechanical braking device. During the clamping process, to produce an electromechanical braking force the electric brake motor drives an axially displaceable transmission element, the axial displacement of which is transmitted to the brake piston and axially displaces said brake piston. The transmission element is for example a spindle nut that sits on a spindle that rotates with the rotor shaft of the electric brake motor. The spindle nut is held rotationally fixedly, especially being guided rotationally fixedly in the brake piston, so that the rotational movement of the spindle results in axial displacement of the spindle nut. During the clamping process, the spindle nut passes axially into contact with the brake piston and displaces said brake piston against the brake disk. During the releasing process in the opposite direction, the spindle nut is displaced into an axially retracted position.

A prerequisite for proper operation of the electromechanical braking device is the relative axial movement between the transmission element and the brake piston, which is only guaranteed however in the case in which the brake piston is not carrying out a rotational movement. If the end face of the brake piston is in contact with the brake lining, a frictional torque that directionally opposes the rotary movement of the brake piston is acting on the brake piston via the end face. In addition, according to the preferred embodiment, a sealing ring is disposed on the periphery of the brake piston on the housing side, which also exerts a frictional torque on the brake piston that opposes a rotational movement of the brake piston.

In the case in which the brake piston releases from the brake lining, the frictional torque acting on the brake piston can however be smaller than a torque in the opposite direction that is exerted on the brake piston by the transmission element. In this case, a rotational movement of the brake piston occurs, so that the brake piston is not axially displaced by the transmission element but rotates together with the transmission element.

Using the method according to the invention, the operability of the electromechanical braking device can be guaranteed, wherein in particular the brake piston is fixed in the rotational direction and rotation of the brake piston with the transmission element—usually the spindle nut—is prevented. For this purpose, a hydraulic braking pressure is produced independently either only in defined initial situations or in all situations before an electromechanical braking force becomes effective, which pressure acts on the brake piston and forces said brake piston against the brake lining, so that a correspondingly high frictional torque is acting on the end face of the brake piston that prevents rotation of the brake piston with the transmission element of the electromechanical braking device. The method is in particular carried out in cases in which the brake piston lies at a distance from the associated brake lining and thus no frictional torque is exerted on the brake piston by the brake lining.

Typical initial situations for carrying out the method are a change of the brake lining and/or the brake disk in the wheel brake device. In these cases, the transmission element of the electromechanical braking device is displaced to a defined end position, for example is moved back to an end stop on the side facing away from the brake piston. Thereupon, the brake piston can be axially retracted, and the end face of the brake piston removed from the adjacent brake lining, whereby the desired brake lining replacement or brake disk replacement is enabled.

In the event of a further clamping process for producing an electromechanical braking force, there is the aforementioned problem that owing to the end face distance from the brake lining, the brake piston may experience no or too little frictional force and may rotate in common with the transmission element, which is driven by the electric brake motor and is accommodated within the brake piston in a positive-fit manner in the rotational direction. Using the method according to the invention, in this situation a hydraulic braking pressure is produced by means of the hydraulic vehicle brake that forces the brake piston axially against the brake lining, so that a sufficiently high frictional torque acts on the brake piston and the brake piston does not carry out any rotational movement during the axial displacement of the transmission element. The brake piston is fixed in the rotational direction and cannot carry out any rotational movement.

For example, the method concerns a phase before generation of the electromechanical braking force, for example to hold the vehicle at a standstill. This can be carried out during a clamping process that is carried out to produce an electromechanical braking force, including the period of time while the engine is idling to overcome the play in the transmission element until reaching the stop position on the brake piston.

It is also possible to carry out the method if the transmission element is disposed at an end stop on the side facing away from the brake piston. The transmission element adopts said position if the brake lining or the brake disk is to be replaced, for example. The electric brake motor is actuated in the releasing direction until the transmission element reaches the end stop and thus adopts the position furthest removed from the brake disk.

A further initial situation concerns the case in which the current position of the transmission element is unknown, for example because of an electrical or mechanical fault. The build-up of hydraulic pressure also displaces the brake piston towards the brake lining in said situation, whereby a frictional torque that opposes a rotational movement of the brake piston is built up between the end face of the brake piston and the brake lining.

The method according to the invention with the automatic build-up and maintenance of the hydraulic braking pressure is carried out at least until the electric brake motor has displaced the transmission element approximately or fully into a defined end position, for example into a stop position, in which the transmission element is either at the end stop on the side facing away from the brake piston or in axial contact with the brake piston. It can be advantageous to build the braking pressure back up again after reaching the stop position. In a further embodiment, by contrast, the hydraulic braking pressure is maintained and may be modulated, i.e. adjusted to an increased or reduced level, so that the entire braking force is composed of a hydraulic component and an electromechanical component. The hydraulic braking pressure is thus also maintained at an unchanged or modified level during the build-up of electromechanical braking force.

It may be sufficient to maintain the hydraulic braking pressure only until the transmission element has approximately reached the end position. In this case, the brake piston may indeed rotate briefly, but only until the end position is reached, which may be acceptable.

According to the advantageous embodiment, the stop position of the transmission element is detected using the current profile of the brake motor. On reaching the stop position, the resistance increases significantly with the further displacement of the transmission element, which can be detected using the corresponding increase in the current profile of the electric brake motor.

According to a further advantageous embodiment, the method for operating the electromechanical braking device is carried out if no electromechanical braking force for producing an electromechanical braking force is still detected after the expiry of a defined period of time during the clamping process. The determination of the electromechanical braking force is carried out as previously described using the current profile of the brake motor, for example. If the electromechanical braking force does not increase after the expiry of the defined period of time, this indicates a malfunction during the actuation of the electromechanical braking device, in particular an unwanted rotation of the brake piston because of too low a frictional torque. In this case the method according to the invention is carried out, during which a hydraulic braking pressure is automatically produced to force the brake piston against the brake lining and to produce a frictional torque opposing rotation of the brake piston.

The steps of the method are carried out in a regulating or control unit, in which actuation signals are produced for actuating the different components of the brake system with the hydraulic vehicle brake and the at least one electromechanical braking device.

Further advantages and advantageous embodiments are to be found in the further claims, the description of the figures and the drawings. In the figures:

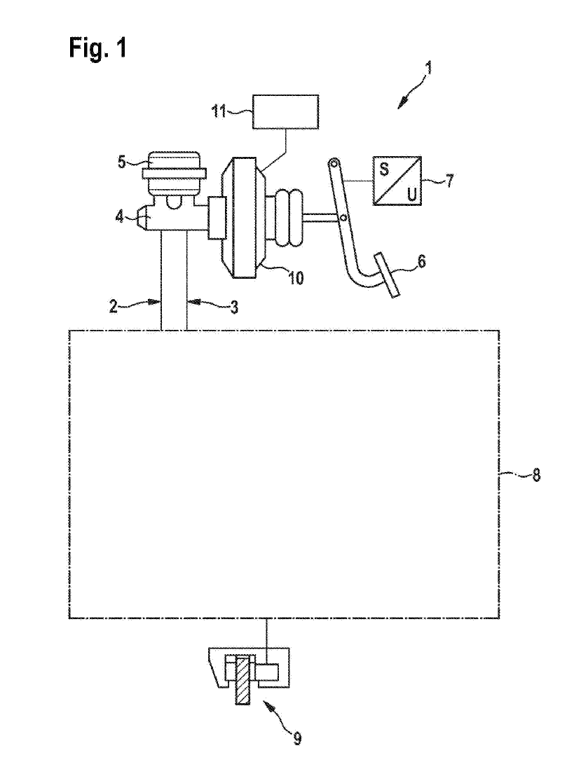

FIG. 1 shows a schematic representation of a hydraulic vehicle brake, wherein the wheel brake device in the vehicle brake on the rear axle of the vehicle additionally comprises a respective electromechanical braking device with an electric brake motor,

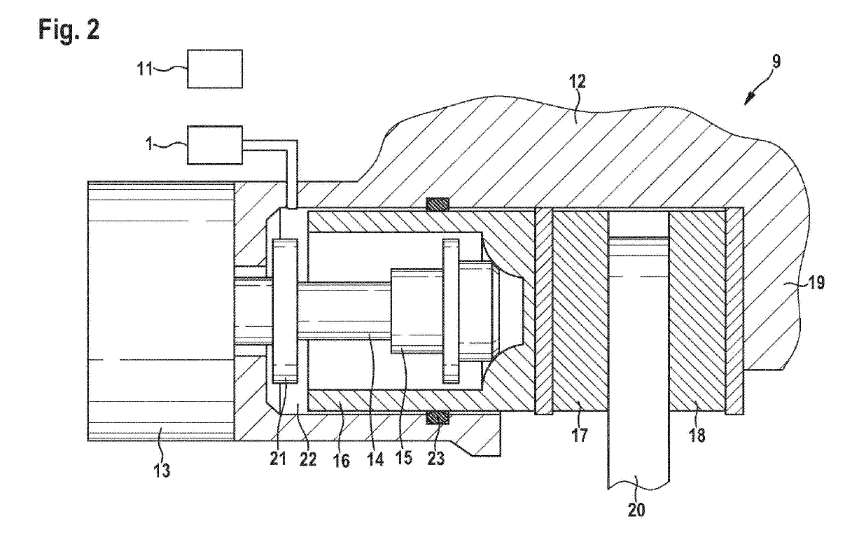

FIG. 2 shows a section through an electromechanical braking device with an electric brake motor,

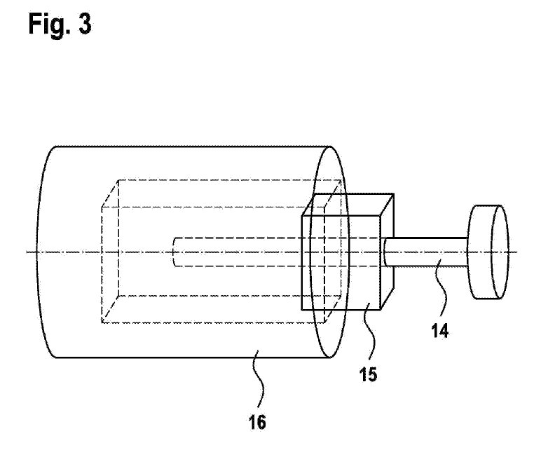

FIG. 3 shows a schematic representation of a spindle nut that is guided in a brake piston in a perspective view,

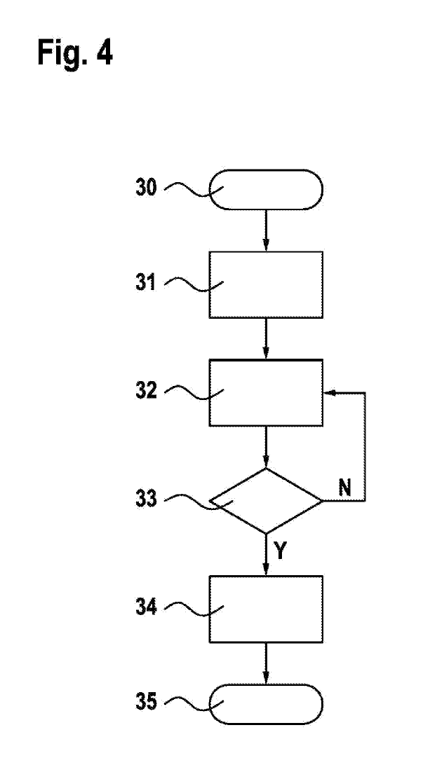

FIG. 4 shows a flow chart for a first method for monitoring the operability of the electromechanical braking device,

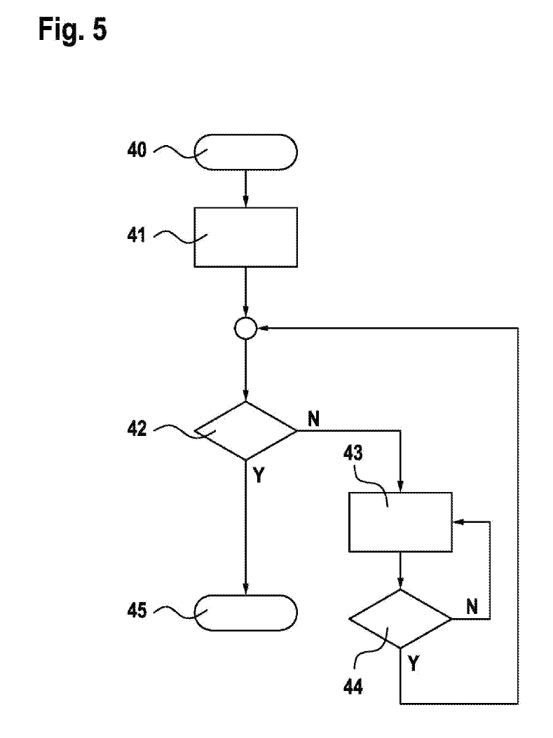

FIG. 5 shows a flow chart for a further method for monitoring the operability of the electromechanical braking device,

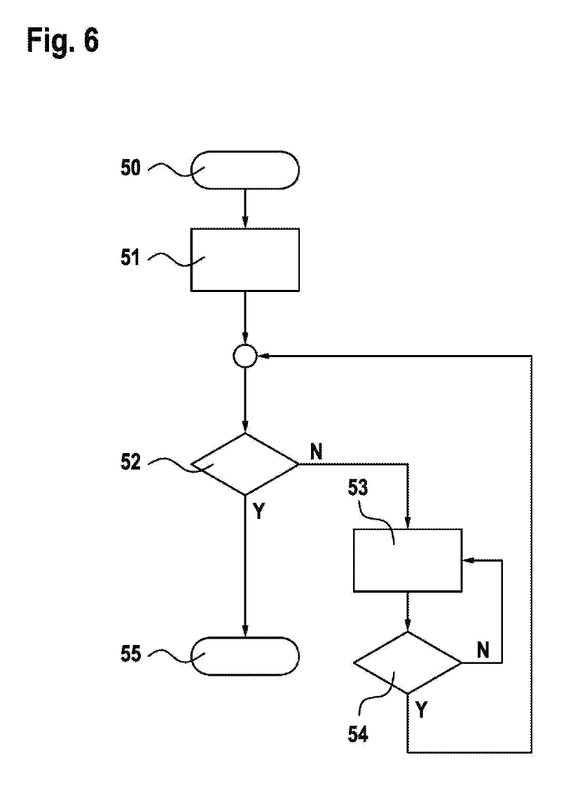

FIG. 6 shows a flow chart for yet another method for monitoring the operability of the electromechanical braking device.

Identical components are provided with the same reference symbols in the figures.

The hydraulic vehicle brake 1 represented in FIG. 1 for a vehicle comprises a front axle brake circuit 2 and a rear axle brake circuit 3 for supplying and actuating wheel brake devices 9 on each wheel of the vehicle with a brake fluid under hydraulic pressure. The two brake circuits 2, 3 are connected to a common master brake cylinder 4 that is supplied with brake fluid by means of a brake fluid supply reservoir 5. The master brake cylinder piston within the master brake cylinder 4 is actuated by the driver by means of the brake pedal 6, and the pedal travel exerted by the driver is measured by means of a pedal travel sensor 7.

Between the brake pedal 6 and the master brake cylinder 4, a braking force booster 10 is disposed, comprising for example a pump motor that is preferably operated via a gearbox of the master brake cylinder 4 (iBooster); the iBooster is preferably an EC motor. The braking force booster 10 forms an electrically controllable actuator for influencing the braking pressure.

The actuation displacement of the brake pedal 6 measured by the pedal travel sensor 7 is transmitted as a sensor signal to a regulating or control unit 11, in which actuation signals for actuating the braking force booster 10 are produced. The supply of the wheel brake devices 9 with brake fluid is carried out in each brake circuit 2, 3 via different switching valves, which in common with further units are part of the brake hydraulics 8. Furthermore, the brake hydraulics 8 include a hydraulic pump that is a component of an electronic stability program (ESP). Also, the pump motor of the ESP hydraulic pump forms an electrically controllable actuator for influencing the braking pressure.

The braking force boosting can additionally or alternatively be carried out using an electrically actuatable actuator that is connected downstream of the master brake cylinder 4 of the vehicle brake 1. In the case of the actuator, the boost is for example provided by means of an electric motor that moves a plunger. Said plunger is disposed after the master brake cylinder and can produce braking pressure in both brake circuits.

In FIG. 2, the wheel brake device 9, which is disposed on a wheel on the rear axle of the vehicle, is represented in detail. The wheel brake device 9 is part of the hydraulic vehicle brake 1 and is supplied with brake fluid 22 from the rear axle brake circuit. The wheel brake device 9 comprises moreover an electromechanical braking device that is preferably used to hold a vehicle at a standstill but can also be used to decelerate the vehicle while the vehicle is moving, in particular at lower vehicle speeds below a speed limit value.

The electromechanical braking device comprises a brake caliper 12 with a claw 19 that encloses a brake disk 20.

As the actuator, the braking device comprises a D.C. electric motor as a brake motor 13, the rotor shaft of which drives a spindle 14 rotationally, on which a spindle nut 15 is rotatably supported. During rotation of the spindle 14, the spindle nut 15 is displaced axially. The spindle nut 15 moves within a brake piston 16 that is the carrier for a brake lining 17 that is forced against the brake disk 20 by the brake piston 16. On the opposite side of the brake disk 20, a further brake lining 18 is disposed that is held positionally fixedly on the claw 19. The brake piston 16 is sealed flow-tight on the outside thereof relative to the accommodating housing by means of an enclosing sealing ring 23.

Within the brake piston 16, the spindle nut 15 can move axially forwards towards the brake disk 20 during a rotary movement of the spindle 14 or axially rearwards until reaching an end stop 21 during an opposite rotary movement of the spindle 14. To produce a clamping force, the spindle nut 15 acts on the inner end face of the brake piston 16, whereby the brake piston 16 that is axially movably supported in the braking device is forced with the brake lining 17 against the facing end face of the brake disk 20.

For the hydraulic braking force, the hydraulic pressure of the brake fluid 22 from the hydraulic vehicle brake 1 acts on the brake piston 16. The hydraulic pressure can also be supportively effective when the vehicle is at a standstill when actuating the electromechanical braking device, so that the total braking force is composed of the electromotively provided component and the hydraulic component. While the vehicle is travelling, either only the hydraulic vehicle brake is active, or both the hydraulic vehicle brake and the electromechanical braking device are active or only the electromechanical braking device is active to produce a braking force. The actuation signals for actuating both the adjustable components of the hydraulic vehicle brake 1 and the electromechanical wheel brake device 9 are produced in the regulating or control unit 11.

The hydraulic braking pressure for carrying out the method is produced automatically. For this purpose, an electric actuator in the hydraulic vehicle brake is actuated, for example a hydraulic pump such as for example an ESP pump (electronic stability program).

In FIG. 3, the brake piston 16 and the spindle nut 15, which is seated on the spindle 14 driven by the motor shaft, are represented schematically. During rotation of the motor shaft, the spindle nut 15 is displaced on the spindle 14 in the axial direction. The spindle nut 15 is accommodated by a positive fit in the rotational direction in the interior of the brake piston 16 and can be axially displaced in the brake piston 16. Because of the positive fit accommodation, a relative rotation of the spindle nut 15 in relation to the brake piston 16 is excluded.

If a sufficiently high frictional torque is acting on the brake piston 16, for example because of the contact of the end face of the brake piston 16 with the brake lining and because of the contact between the sealing ring 23 (FIG. 2) and the casing surface of the brake piston 16, the brake piston 16 remains in the rotationally fixed position thereof, while the spindle nut 15 is displaced in the axial direction by the spindle 14. If by contrast the frictional torque decreases, for example in the case of an axial distance between the end face of the brake piston 16 and the brake lining, the situation can occur in which the spindle nut 15 rotates in common with the brake piston 16.

In the following FIGS. 4 through 6, procedures for monitoring and ensuring the operability of the electromechanical braking device are represented. The represented method is based on the initial situation in which the end face of the brake piston 16 lies at a distance from the brake lining, so that only a small frictional torque is acting on the brake piston 16, which may not be sufficient to fix the brake piston 16 in a rotationally fixed position. Using the represented method, it is possible in said initial situation to fix the brake piston in the rotational direction, so that during a drive movement of the electric brake motor and the spindle 14, the spindle nut 15 is axially displaced within the brake piston 16.

In the flow chart represented in FIG. 4, after the start in the step 30 of the method, in the subsequent step 31 the electric brake motor of the electromechanical braking device is actuated, so that the brake piston reaches the operating position. In the initial situation, the spindle nut is disposed at an end stop on the side facing away from the brake piston. This enables the brake piston to be brought axially into a position at a distance from the brake lining, so that the brake lining or the brake disk can be replaced. Following this, with the method represented in FIG. 4 the spindle nut is moved away from the end stop again and the brake piston is brought into the operating or initial position for a subsequent braking process.

In the subsequent step 32, a hydraulic braking pressure is automatically produced by means of an electrically actuatable actuator of the hydraulic vehicle brake on those wheel brake devices on which the electromechanical braking device is also disposed. Because of the hydraulic braking pressure, the brake piston is displaced towards the brake lining and is forced against the brake lining, so that a rotary movement of the brake piston is prevented.

In the subsequent step 33, a check is carried out as to whether the hydraulic setpoint braking pressure has already been reached. If this is not the case, the no branch (“N”) is subsequently returned to the step 32 again and the hydraulic braking pressure is increased further by automatically actuating the actuator in the hydraulic vehicle brake.

If the result of the query in the step 33 is that the hydraulic setpoint braking pressure has been reached, the yes branch (“Y”) is subsequently advanced to the next step 34, in which the electric brake motor of the electromechanical braking device is actuated, so that with the brake piston being held rotationally fixedly, the spindle nut is displaced axially within the brake piston until the operating position of the spindle nut is reached. Then the method is ended in the step 35.

Following the represented method, an electromechanical braking force can be built up with further actuation of the electric brake motor.

The embodiment version according to FIG. 5 is based on the initial situation, wherein the position of the spindle nut is unknown because of an electrical or mechanical fault. Following the start of the method in the step 40, in the next step 41 the closing process in the electromechanical braking device is started to displace the spindle nut towards the initial position for a build-up of electromechanical braking force. In the step 42, the query is carried out as to whether a braking force build-up is detected, for example using the check of the current profile in the electric brake motor. If no electromechanical braking force build-up is detected, the no branch is then advanced to the step 43, according to which by actuating the actuator in the hydraulic vehicle brake a hydraulic braking pressure is automatically built up that forces the brake piston against the brake lining. In the step 44, the query is carried out as to whether the setpoint braking pressure has been achieved. If this is not the case, the no branch is then returned back to the step 43 again and the build-up of the hydraulic braking pressure is continued. Otherwise, the setpoint braking pressure is reached, then the yes branch is returned to the start of the step 42 of the method and another check is made as to whether a build-up of electromechanical braking force occurs with further actuation of the electric brake motor. If this is the case, the yes branch is then advanced to the step 45 and the method is ended.

The process of the method according to FIG. 6 is based on the initial situation in which the spindle nut is to be displaced to the end stop, which is disposed on the side facing away from the brake piston. This is a prerequisite for the brake piston being able to be displaced for a change of the brake lining or the brake disk, for example.

After the start of the method in the step 50, the actuation of the electric brake motor towards the open position to reach the end stop is carried out in the step 51. In the step 52, the query is carried out as to whether the spindle nut is disposed at the end stop, which for example can be determined using the current profile of the electric brake motor, which increases on reaching the end stop.

If the result of the query in the step 52 is that it is not determined that the spindle nut is disposed at the end stop, the no branch is then advanced to the next step 53, according to which a hydraulic setpoint braking pressure is produced by actuating the hydraulic actuator in order to fix the brake piston. In the step 54, a check is carried out as to whether the setpoint braking pressure has been reached; if this is not the case, the no branch is then returned back to the step 53 and the further build-up of hydraulic braking pressure is continued.

Otherwise, the hydraulic setpoint braking pressure is reached, and the yes branch is then returned back to the start of the method 52. If the result of the query in the step 52 is now that the spindle nut is disposed at the end stop, the yes branch can then be advanced to the step 55, and the method is then ended.

1. A method for operating at least one electromechanical braking device with an electric brake motor in a vehicle, a brake system of the vehicle comprising a hydraulic vehicle brake, the method comprising:
hydraulic braking pressure of the hydraulic vehicle brake and the electric brake motor acting on the same brake piston of a wheel brake device;
transferring rotary movement of the electric brake motor by an axially displaceable transmission element into an axial force on the brake piston; and
when the brake piston lies at a distance from an associated brake lining, fixing the brake piston in the hydraulic vehicle brake by an automatically produced hydraulic braking pressure at least until the electric brake motor has displaced the transmission element one of approximately and fully into an end position.

2. The method as claimed in claim 1, performed when, in an initial position, the transmission element is one of axially at and adjacent to an end stop on the side facing away from the brake piston.

3. The method as claimed in claim 2, performed when axial position of the transmission element in the initial position is unknown.

4. The method as claimed in claim 1, performed following one of a brake lining replacement and a brake disk replacement.

5. The method as claimed in claim 1, wherein the end position of the transmission element is a stop position.

6. The method as claimed in claim 5, wherein the stop position of the transmission element is determined using a current profile of the brake motor.

7. The method as claimed in claim 1, performed when no electromechanical braking force is determined following expiry of a defined period of time when clamping the electric brake motor.

8. A regulating or control unit configured to carry out the method as claimed in claim 1.

9. A brake system in a vehicle, the brake system comprising:
a hydraulic vehicle brake configured to act on a brake piston of a wheel brake device;
an electromechanical braking device with an electric brake motor, the electric brake motor configured to act on the brake piston of the wheel brake device, wherein rotary movement of the electric brake motor is transferred by an axially displaceable transmission element into an axial force on the brake piston; and
a regulating or control unit configured to actuate adjustable components of the brake system such that, when the brake piston lies at a distance from an associated brake lining, the brake piston is fixed in the hydraulic vehicle brake by an automatically produced hydraulic braking pressure at least until the electric brake motor has displaced the transmission element one of approximately and fully into an end position.

10. The brake system as claimed in claim 9, wherein the hydraulic vehicle brake is equipped with an electrically controllable actuator configured to influence the hydraulic pressure.

11. The brake system as claimed in claim 9, wherein wheel brake devices on a rear axle of the vehicle are equipped with electromechanical braking devices.

12. A vehicle, comprising:
a brake system, the brake system including:
a hydraulic vehicle brake configured to act on a brake piston of a wheel brake device;
an electromechanical braking device with an electric brake motor, the electric brake motor configured to act on the brake piston of the wheel brake device, wherein rotary movement of the electric brake motor is transferred by an axially displaceable transmission element into an axial force on the brake piston; and
a regulating or control unit configured to actuate adjustable components of the brake system such that, when the brake piston lies at a distance from an associated brake lining, the brake piston is fixed in the hydraulic vehicle brake by an automatically produced hydraulic braking pressure at least until the electric brake motor has displaced the transmission element one of approximately and fully into an end position.

13. The brake system as claimed in claim 10, wherein the electrically controllable actuator is an ESP pump.
